(19) United States
(12) Patent Application Publication
(10) Pub. No.: US 2017/0001495 A1
(43) Pub. Date: Jan. 5, 2017

(54) Paneling Element of a Vehicle Roof Having a Glass Support

(71) Applicant: WEBASTO SE, Stockdorf (DE)

(72) Inventor: Michael DEPPE, Stockdorf (DE)

(21) Appl. No.: 15/120,982

(22) PCT Filed: Feb. 24, 2015
(86) PCT No.: PCT/DE2015/100076

§ 371 Date: Aug. 23, 2016

(30) Foreign Application Priority Data
Mar. 25, 2014 (DE) 20 2014 101 393.8

(51) Int. Cl. B60J 1/20; B60J 7/043

(52) U.S. Cl. CPC B60J 1/2094; B60J 7/043

(57) ABSTRACT

A plate-like paneling element of a vehicle roof, having a support plate having a glass panel provided with a shatter protection film being a composite film arrangement. The composite film arrangement can have a first plastic film and a second plastic film which are connected to each other and at least one of which has a coating directly applied without an adhesive to the surface facing the other one of the two plastic films for absorbing and/or reflecting infrared radiation and/or UV radiation.

The invention relates to a plate-like paneling element for a vehicle roof having the features of the preamble of claim 1.

A plate-like paneling element of this kind is known from practice and can be realized as a cover element of a sliding roof arrangement. The cover element comprises a support plate consisting of a glass panel, to the underside of which a shatter protection film is glued. Said shatter protection film prevents pieces of broken glass from falling into the vehicle interior and thus onto vehicle passengers in case the glass panel is destroyed or damaged. Instead, the shatter protection film ensures that the composite consisting of the support plate and the shatter protection film stays intact even if the glass panel breaks or shatters.

The above-described cover element of a sliding roof arrangement presents the problem that in case of intense sunshine, a large amount of heat may be introduced into the vehicle interior via the vehicle roof.

The object of the invention is to provide a plate-like paneling element of the kind described above that is optimized in view of a potential introduction of heat into the interior of the vehicle in question.

This object is attained according to the invention by the plate-like paneling element of a vehicle roof having the features of claim 1.

Thus, it is the core of the invention that the composite film arrangement forming the shatter protection film comprises at least a first plastic film and a second plastic film, at least one of which is provided with a coating on the side facing the other plastic film, said coating serving to absorb and/or reflect infrared radiation and/or UV radiation.

In case of the paneling element according to the invention, the composite film arrangement can be produced by simply connecting, namely laminating or gluing together, the two plastic films. Other laminating or gluing processes for connecting a layer absorbing infrared radiation and/or UV radiation are not required. Thus, the composite film arrangement of the paneling element according to the invention is characterized by a cost-effective production process.

The coating for absorbing and/or reflecting infrared radiation and/or UV radiation is preferably made of at least one organic or inorganic substance deposited on the respective plastic film. For example, the coating can be made of a noble metal, such as silver, of an oxide or of an organic compound.

The coating is preferably made of a vapor-deposited layer or of a sputter layer (cathode evaporation).

At least one of the two plastic films is made of a clear polyethylene terephthalate (PET) film. Preferably, both of the two connected plastic films are made of a polyethylene terephthalate (PET) material. Advantageously, said material is particularly clear so as to ensure high transparency of the paneling element according to the invention.

In a specific embodiment of the arrangement, the two plastic films, at least one of which is provided with a coating, are glued together or connected to each other via another laminating process.

The shatter protection film is preferably glued to the support plate consisting of the glass panel. Hence, it preferably comprises an adhesive layer via which it is connected to the glass panel.

In an advantageous embodiment, to ensure that the paneling element according to the invention will have an aesthetically pleasing optical appearance even after prolonged use, the side of the shatter protection film facing away from the support plate is provided with a scratch-proof and/or tear-proof coating, which can consist of a separate film laminated to the composite film arrangement.

At its edge, the support plate, which is made of the glass panel, can be provided with foam or an encapsulation overlapping the shatter protection film. There can be a material-bonded connection and a form fit between the foam and the shatter protection film. The shatter protection film thus acts in the manner of a safety net tightly clamped at the edges, which catches any pieces of broken glass of the support plate before they can enter the vehicle interior.

The paneling element according to the invention can be a glass cover of a sliding roof arrangement or another type of body-fixed element of a vehicle roof arrangement.

Other advantages and advantageous embodiments become apparent from the description, the drawing and the claims.

An embodiment of a plate-like paneling element according to the invention is illustrated in the drawing in a schematically simplified manner and will be explained in more detail in the following description. In the drawing:

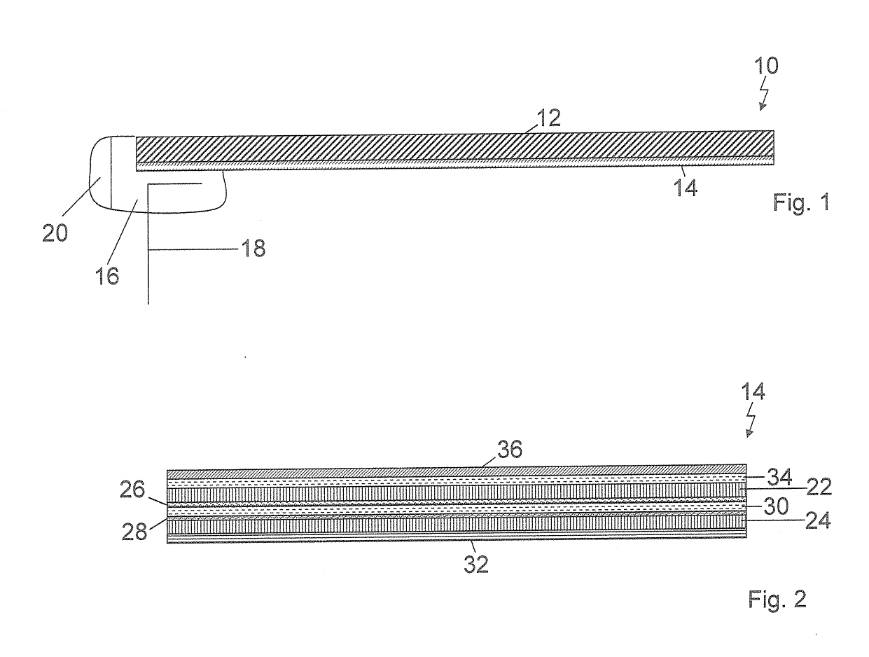

FIG. 1 shows a cut through a lateral edge region of a glass cover of a sliding roof arrangement; and

FIG. 2 shows a cut through a shatter protection film of the glass cover of FIG. 1.

In the drawing, a glass cover 10 is illustrated, which is part of a roof opening system of an automobile and serves to close and at least partially open a roof opening of a vehicle roof The glass cover 10, consequently being a plate-like paneling element of a vehicle roof, comprises a support plate 12, which is made of a glass panel and whose upper side forms an outer visible surface of the paneling element. At its underside, the transparent support plate 12 has a shatter protection film 14, which serves to prevent pieces of broken glass from entering the interior of the vehicle in question and causing harm to passengers in case the glass panel breaks. The shatter protection film 14 is glued onto the underside of the support plate 12.

The support plate 12, which is provided with the shatter protection film 14, is provided with polyurethane foam 16 at its edge in the manner of a frame, said foam serving to connect functional elements, such as a cover carrier 18, via which the glass cover 10 is connected to kinematics of the sliding roof arrangement. Additionally, the polyurethane foam 16 serves as a support for a circumferential edge-gap seal of the glass cover 10. As can be taken from FIG. 1, the polyurethane foam 16 overlaps an edge strip of the shatter protection film 14, the latter thus being provided with an additional mechanical connection to the support plate 12 in its edge region.

The shatter protection film 14 is made of a composite film arrangement, which is illustrated in detail in FIG. 2 by way of a sectional illustration.

The composite film arrangement, which forms the shatter protection film 14, comprises a core structure made of a first plastic film 22 and a second plastic film 24, each of which is made of a particularly clear polyethylene terephthalate (PET) material. Both of the plastic films 22 and 24 are connected to a respective silver layer 26, which is deposited by sputtering and serves to absorb or reflect infrared radiation. The two plastic films 22 and 24, which are provided with the coatings 26 and 28, respectively, are connected to each other via an adhesive layer 30 at the sides carrying the coatings 26 and 28.

On the side facing away from coating 28, the plastic film 24 is provided with a scratch-proof and/or tear-proof coating 32, which can consist of another film. The coating 32 forms the inner visible surface of the glass cover 10.

For being connected to the support plate 12, the shatter protection film has another adhesive layer 34 on the side facing away from coating 32. In its condition upon delivery, i.e. prior to application of the shatter protection film 14 to the support plate 12, the adhesive layer 34 is provided with a protective film or separating film 36.

### REFERENCE SIGNS

10 glass cover
12 support plate
14 shatter protection film
16 polyurethane foam
18 cover carrier
20 edge-gap seal
22 plastic film
24 plastic film
26 coating
28 coating
30 adhesive layer
32 coating
34 adhesive layer
36 separating film

1. A plate-like paneling element for a vehicle roof, comprising: a support plate consisting of a glass panel provided with a shatter protection film being a composite film arrangement, wherein the composite film arrangement comprises a first plastic film and a second plastic film which are connected to each other and at least one of which has a coating directly applied without an adhesive to the surface facing the other one of the two plastic films for absorbing and/or reflecting infrared radiation and/or UV radiation.

2. The plate-like paneling element according to claim 1, wherein the coating is made of at least one organic or inorganic substance deposited on the respective plastic film.

3. The plate-like paneling element according to claim 1, wherein the coating is made of a noble metal.

4. The plate-like paneling element according to claim 1, wherein the coating is made of a vapor-deposited layer or of a sputter layer.

5. The plate-like paneling element according to claim 1, wherein at least one of the two plastic films is made of a PET material.

6. The plate-like paneling element according to claim 1, wherein the two plastic films are glued together.

7. The plate-like paneling element according to claim 1, wherein the shatter protection film has an adhesive layer via which it is glued to the support plate.

8. The plate-like paneling element according to claim 1, wherein on its side facing away from the support plate, the shatter protection film is provided with a scratch-poof and/or tear-proof coating.

9. The plate-like paneling element according to claim 1, wherein the edge of the support plate is provided with a foamed or injection-molded edge encapsulation overlapping the shatter protection film.

10. The plate-like paneling element according to claim 1, wherein it is a glass cover of a sliding roof arrangement or a roof element fixed to a vehicle body.

11. The plate-like paneling element according to claim 3 wherein the noble metal coating is silver.

12. The plate-like paneling element according to claim 5, wherein the PET material is clear.

13. The plate-like paneling element according to claim 5, wherein the scratch-poof and/or tear-proof coating is made of film.
